(19) United States
(12) Patent Application Publication
(10) Pub. No.: US 2015/0187034 A1
(43) Pub. Date: Jul. 2, 2015

(54) SYSTEMS AND METHODS FOR NETWORK-ISOLATED DATA TRANSFER

(71) Applicant: General Electric Company, Schenectady, NY (US)

(72) Inventors: Paul Mullen, Waukesha, WI (US); Mark Urness, Wauwatosa, WI (US); Eric Severson, Madison, WI (US)

(73) Assignee: General Electric Company, Schenectady, NY (US)

(21) Appl. No.: 14/141,966

(22) Filed: Dec. 27, 2013

(51) Int. Cl. G06Q 50/22; G06Q 50/24; G06K 19/06

(52) U.S. Cl. CPC G06Q 50/22; G06K 19/06112; G06Q 50/24; G06K 19/06037

(57) ABSTRACT

A computerized medical system includes a non-transient computer-readable memory, a display screen, and a controller in communication with the non-transient computer-readable memory and the display screen. The controller is configured to display an optically machine-readable code on the display screen, where the optically machine-readable code corresponds to a request for data that is unavailable within the computerized medical system.

### BACKGROUND

The invention generally relates to data transfer between a network and a network-isolated system. More specifically, the invention relates to providing networked support for electronic devices, including medical systems, which are stand-network-isolated for both infrastructure and security reasons.

In the course of operating any computerized work station, a fault or other condition that requires external assistance may occur. Where the computerized work station is network-isolated or only part of a local-area network (LAN), external technical support is unavailable through a traditional web-based support center.

The invention also relates to other data transfer between a network and a network-isolated system. For security reasons, network-isolated stand-alone devices or work stations may also not include traditional data transfer means, such as a CD-ROM drive, USB port, or other receptacles for receiving external memory devices. While the inability to receive an external memory device is advantageous for minimizing security risks, it can create practical difficulties when it is necessary to transfer data, such as patient demographic data, from a networked database to the network-isolated system.

### SUMMARY OF THE INVENTION

In one embodiment, the invention provides a computerized medical system. The computerized medical system includes a non-transient computer-readable memory, a display screen, and a controller in communication with the non-transient computer-readable memory and the display screen. The controller is configured to display an optically machine-readable code on the display screen, where the optically machine-readable code corresponds to a request for data that is unavailable within the computerized medical system.

In another embodiment, the invention provides a method of operating a network-isolated medical system comprising a non-transient computer-readable memory, a display screen, and a controller in communication with the non-transient computer-readable memory and the display screen. The method includes displaying an optically machine-readable code on the display screen, where the optically machine readable code corresponding to a request for data. The optically machine-readable code is scanned with a portable electronic device. A network database is accessed with the portable electronic device in response to the scanning.

### BRIEF DESCRIPTION OF THE DRAWINGS

FIG. 1 is a block diagram of a computerized medical system, according to a preferred embodiment of the invention.

FIG. 2 is flow chart illustrating operation of the computerized medical system of FIG. 1.

FIG. 3 is a block diagram of a computerized medical system according to another preferred embodiment of the invention.

FIG. 4 is a flow chart illustrating operation of the computerized medical system of FIG. 3.

### DETAILED DESCRIPTION

In the following detailed description, reference is made to the accompanying drawings that form a part hereof, and in which is shown by way of illustration specific embodiments, which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

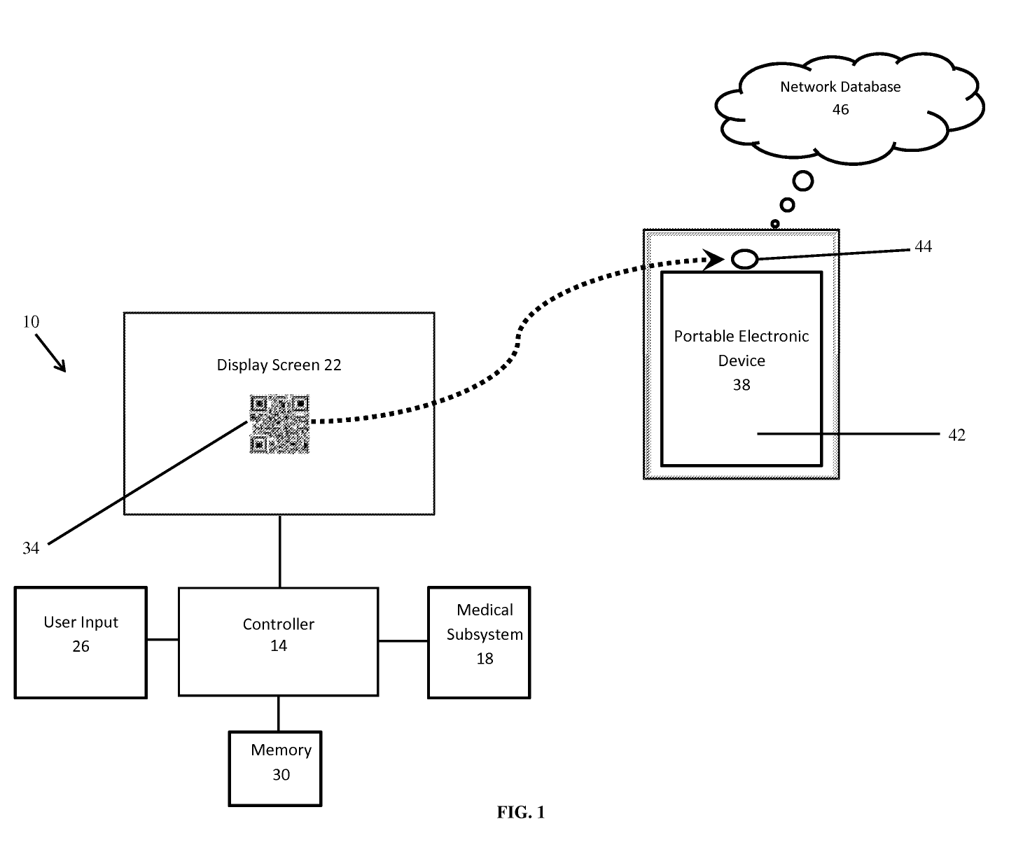

FIG. 1 illustrates one embodiment of network-isolated system, such as a computerized medical system 10. The medical system includes a controller 14, a medical subsystem 18, a display screen 22, a user input 26, and a non-transient computer-readable memory 30. The controller 14 includes a processor, such as a programmable microprocessor. The controller 14 is in communication with the medical subsystem 18, the user input 22, the display screen 26, and the memory 30.

In one example, the medical subsystem 18 includes a medical imaging system such as an ultrasound, X-ray, MRI, or CT system, or combinations thereof. In another example, the medical subsystem may be a respirator, anesthesia system, patient monitoring system, or combinations thereof. The medical subsystem 18 is in two-way communication with the controller 14, such that control signals may be communicated from the controller 14 to the medical subsystem 18, and data collected by the medical subsystem 18 may be returned to the controller 14 for processing and display on the display screen 22. The data collected by the medical subsystem 18 may include diagnostic or guidance image data, vital signs, or other patient telemetry.

The display screen 22 may be a CRT, LCD, plasma, or other known screen type. The display screen receives display signals from the controller. The user input 26 may be, for example, a keyboard, mouse, trackball, touch pad or other known input device. In some embodiments, the user input 26 and the display screen 22 may be combined in the form of a touchscreen display, as is well-known in the art.

The memory 30 stores a plurality of signal processing, display, and communication algorithms for execution by the controller. The memory 30 also defines a plurality of data fields for receiving, for example, patient demographic information, imaging parameters, or comparative data. The memory 30 additionally stores a plurality of optically machine-readable codes which may be selectably or automatically displayed on the display screen 22. As illustrated in FIG. 1, an optically machine-readable code 34 may take the form of a two-dimension code, such as a QR-code 34. In other embodiments, the optically machine readable code may be another type of two-dimensional code. In still other embodiments, the optically machine readable code may be a one-dimensional code, such as a barcode.

With continued reference to FIG. 1, the medical system 10 may be used in conjunction with a portable electronic device 38. The portable electronic device 38 may be, for example, a smartphone such as an Apple iPhone and equivalents thereof, or a tablet computer such an Apple iPad and equivalents thereof. The portable electronic device 38 includes a display 42, such as a touchscreen display, and a camera 44. With appropriate application software, as known in the art of portable electronic devices, the camera 44 can function as an optical scanner for reading an optically machine readable codes (e.g., the optically machine readable code 34 of the medical system 10). The portable electronic device is in wireless communication with a network database 46, such as the internet or a specialized network. The wireless connection may take the form of a wireless local area network (WLAN), such as a Wi-Fi connection, or a wireless telecommunication network (e.g., a 3G or 4G telecommunications network).

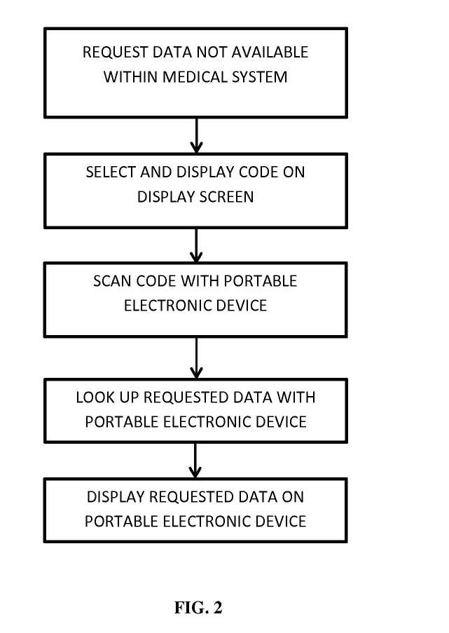

Referring to FIGS. 1 and 2, a user request for information or support not available within the medical system 10 is made through a manual selection on the user input 26. In response to the manual selection on the user input, the controller selects an optically machine readable code (e.g., the QR code 34) for display on the display screen 22. The selected and displayed QR code corresponds to the user request.

With the machine readable code 34 displayed on the display screen of the medical system, the user scans the machine readable code 34 with the camera (i.e., scanner) of the portable electronic device 38. The portable electronic device 38 identifies the machine readable code and responds by looking up the requested information. Depending on the request, the requested information may be found internally on the portable electronic device, or it may be accessed from the external network database. The portable electronic device may also forward an email, SMS, or other messages to a support center with the data needed to provide customer support.

Once the requested information is identified and received by the portable electronic device 38, it is displayed on the touchscreen display 42. If, for example, the user has requested technical support, or “help” assistance, then technical support information or instructions will appear on the display 42 of the portable electronic device 38, in order to guide the user to a solution. In another example, the user may request an ideal or comparative reference image to display on the portable electronic device, for comparison to image data displayed on the display screen of the medical system. In another example, the user may request live support from another medical professional.

In some embodiments, the machine readable code 34 may be displayed automatically in response to the controller detecting a pre-defined condition. Examples of pre-defined conditions may include a fault with the medical subsystem, or a data field that is required to be filled prior to completion of a process or algorithm.

In some embodiments, the machine readable code 34 may include data, including patient data, to be uploaded to an external database. In these embodiments, the machine readable code 34 includes embedded data, rather than merely being a request for data. The data is then uploaded to the portable electronic device 38 by scanning the optically machine readable code 34 with the camera 44. The data embedded in the optically machine readable code 34 may then be uploaded to the network database 46 from the portable electronic device 38 for further analysis or storage.

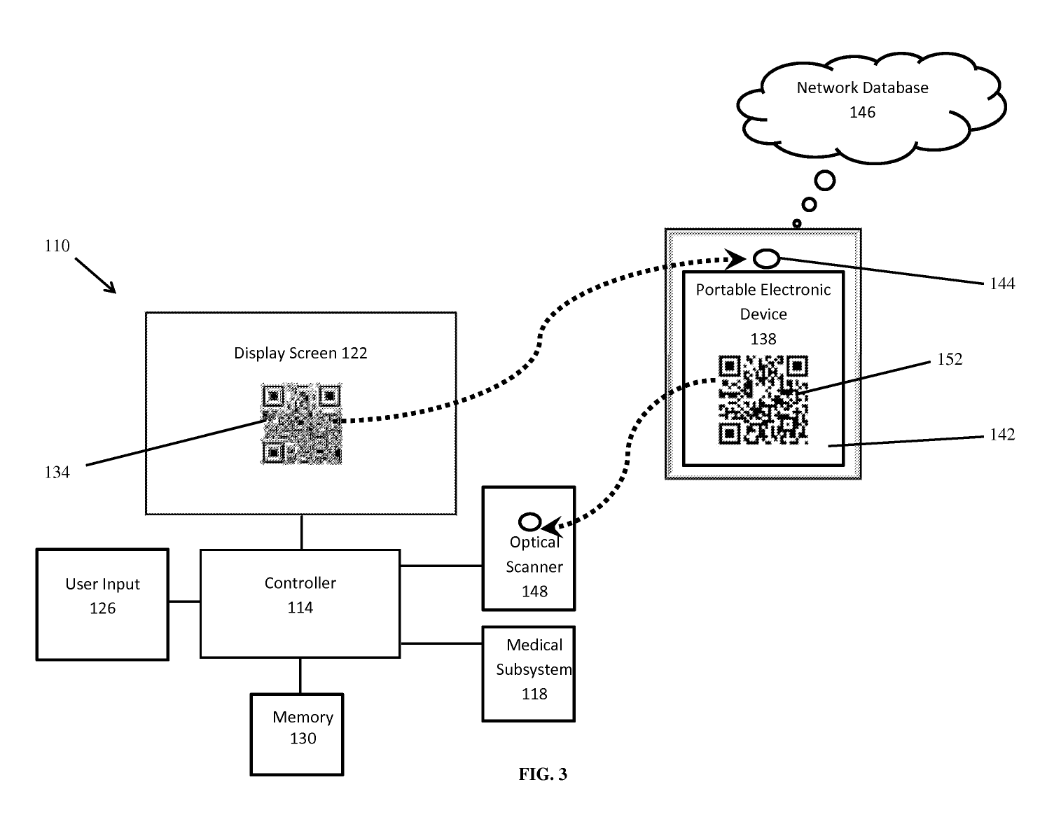

FIG. 3 illustrates a medical system 110 according to another embodiment of the invention. The medical system 110 has substantial similarities to the medical system 10 described previously, and only the differences will be described herein. Similar components to those described with respect to the medical system 10 have been given similar reference numerals, with the addition of 100.

The medical system 110 includes a controller 114, a medical subsystem 118, a display screen 122, a user input 126, and a non-transient memory 130, as described with respect to the medical system 10. The medical system 110 further includes an optical scanner 148. The optical scanner 148 is in communication with the controller 114 and is configured for reading optically machine readable codes 152, such as the QR code 152 displayed on a portable electronic device 138. The optical scanner 148 may be, for example, a camera.

Including the optical scanner 148 with the medical system 110 provides for secure two-way communication between the network-isolated medical system 110, and a network database 146, using a portable electronic device 138 as an intermediary. Thus, the medical system 110 remains network-isolated for security and infrastructure reasons, while having the benefit of being able to upload and download data to the network database via the optically machine readable codes.

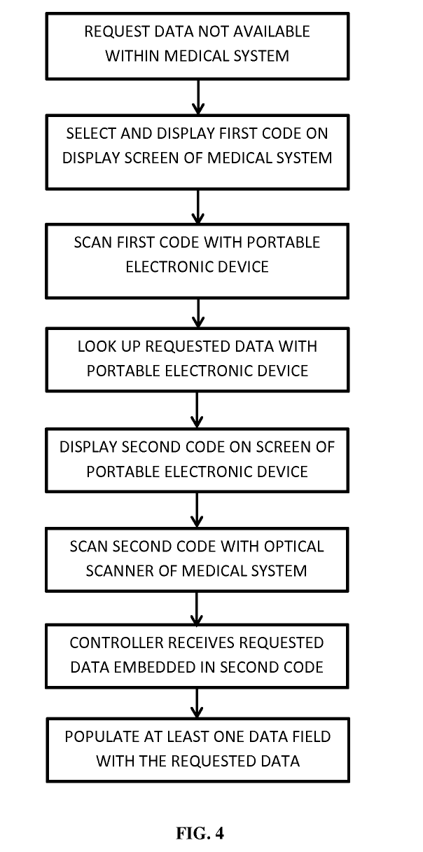

Referring to FIGS. 3 and 4, a user request for information or support not available within the network-isolated medical system 110 is made through a manual selection on the user input 126. In response to the manual selection on the user input, the controller 114 selects a first optically machine readable code 134 (e.g., the QR code 134) for display on the display screen 122. The selected and displayed QR code corresponds to the user request, such as a request for patient information, operating parameters, or other data unavailable internally within the medical system 110. Alternatively, the selection and display of the optically machine readable code may occur automatically, in response to a predefined condition.

With the machine readable code 134 displayed on the display screen of the medical system, the user scans the machine readable code 134 with a camera 144 of portable electronic device 138. The portable electronic device 138 identifies the machine readable code 134 and responds by looking up the requested information. Depending on the request, the requested information may be found internally on the portable electronic device 138, or it may be accessed from the external network database 146.

Once the requested information is identified and received by the portable electronic device 138, a second optically machine readable code 152 is generated and displayed on the display 142. The second optically machine readable code 152 includes embedded data or data fields corresponding to the requested information. The code 152 is scanned with the optical scanner 148 and a signal corresponding to the scan is received by the controller 114. The controller 114 processes the signal to download the data or data fields embedded in the second optically machine readable code 152. Thus, the medical system 110 remains network isolated, yet is capable of two-way communication with a network database by first displaying a first optically machine readable code 134 on the display, and subsequently scanning a second optically machine readable code 152 displayed on the portable electronic device 138.

In some embodiments, the machine readable codes as described herein may include embedded security credentials that provide for authentication between the medical system and the portable electronic device. In these embodiments, only medical systems and portable electronic devices configured to receive and authenticate the security credentials may be used with one another. Such security credentials provide additional security advantages when dealing, for example, with confidential patient health information.

The systems and methods described herein may be used in conjunction with the systems and methods described in U.S. patent application Ser. No. 12/878,423 and U.S. patent application Ser. No. 12/981,792, the contents of both of which are incorporated by reference herein in their entirety.

Thus the invention provides systems and methods for network isolated data transfer. Various features of the invention are set forth in the following claims.

1. A computerized medical system, comprising:
a non-transient computer-readable memory;
a display screen for displaying a medical image;
a controller in communication with the non-transient computer-readable memory and the display screen, the controller configured to display an optically machine-readable code on the display screen, the optically machine-readable code corresponding to a request for data that is unavailable within the computerized medical system.

2. The computerized medical system of claim 1, wherein the optically machine-readable code is stored within the non-transient computer-readable memory.

3. The computerized medical system of claim 2, wherein the non-transient computer-readable memory stores a plurality of optically machine readable codes, where the codes are available for display on the display screen.

4. The computerized medical system of claim 3, wherein the displayed optically machine readable code is situationally dependent.

5. The computerized medical system of claim 3, further comprising a user input in communication with the processor, wherein the processor selects and displays an optically machine readable code of the plurality of optically machine readable codes in response to receiving a user input signal from the user input.

6. The computerized medical system of claim 1, wherein the optically machine readable code is automatically displayed in response to a pre-defined condition.

7. The computerized medical system of claim 1, further comprising a portable electronic device configured to read the optically-machine readable code.

8. The computerized medical system of claim 1, wherein the optically machine-readable code comprises a medical support request.

9. The computerized medical system of claim 1, wherein the optically machine-readable code comprises a technical support request.

10. The computerized medical system of claim 1, wherein the data comprises patient information.

11. The computerized medical system of claim 1, wherein the optically-readable code comprises a two-dimensional code matrix code.

12. The computerized medical system of claim 1, further comprising an optical scanner for scanning a second optically machine-readable code displayed on the screen of a portable electronic device, the optical scanner in communication with the processor and computer readable memory.

13. The computerized medical system of claim 12, wherein the controller is further configured to receive a signal from the optical scanner and process the signal to populate at least one data field of the non-transient computer-readable memory, where the signal corresponds to the request for data.

14. The computerized medical system of claim 12, wherein the controller is further configured to receive a signal from the optical scanner and display data derived from the signal on the display screen, where the signal corresponds to the request for data.

15. A method of operating a network-isolated medical system comprising a non-transient computer-readable memory, a display screen, and a controller in communication with the non-transient computer-readable memory and the display screen, the method comprising:
displaying an optically machine-readable code on the display screen, the optically machine readable code corresponding to a request for data by the network-isolated medical system;
scanning the optically machine-readable code with a portable electronic device; and
accessing a network database with the portable electronic device in response to the scanning, wherein accessing the network comprises looking up the data.

16. The method of claim 15, further comprising displaying the data on the portable electronic device.

17. The method of claim 15, further comprising:
providing the medical system with an optical scanner in communication with the controller;
displaying a second optically machine readable code on the portable electronic device, the second optically machine readable code corresponding to the data;
optically scanning the second optically machine readable code with the optical scanner; and
populating at least one data field of the non-transient computer-readable memory with data embedded in the second optically machine readable code.

18. The method of claim 17, wherein the requested data comprises patient data.

19. The method of claim 15, wherein the requested data comprises reference medical images.

20. The method of claim 15, wherein the requested data comprises technical support information.
